(19) United States
(12) Patent Application Publication
(10) Pub. No.: US 2026/0179301 A1
(43) Pub. Date: Jun. 25, 2026

(54) EFFECT PROCESSING METHOD, APPARATUS, ELECTRONIC DEVICE AND STORAGE MEDIUM

(71) Applicant: BEIJING ZITIAO NETWORK TECHNOLOGY CO., LTD., Beijing (CN)

(72) Inventors: Jinyuan CAO, Beijing (CN); Bailin LI, Beijing (CN); Guang ZENG, Beijing (CN); Wenyue LI, Beijing (CN); Xinyu LI, Beijing (CN); Yunhao LI, Beijing (CN)

(21) Appl. No.: 19/124,799

(22) PCT Filed: Oct. 16, 2023
(86) PCT No.: PCT/CN2023/124826

§ 371 Date: Apr. 25, 2025

(30) Foreign Application Priority Data
Oct. 25, 2022 (CN) 202211314027.9

(51) Int. Cl. G06T 15/00; G06T 11/60; G06T 15/50

(52) U.S. Cl. CPC G06T 15/005; G06T 11/60; G06T 15/506

(57) ABSTRACT

Embodiments of the present disclosure provide an effect processing method and apparatus, an electronic device, and a storage medium. The method comprises: responding to an effect trigger operation for a target effect; when filamentous object rendering occurs in an effect subject corresponding to the target effect, determining an effect guide map of the effect subject, wherein the effect guide map comprises a basic model of the effect subject and a key guide line representing a filamentous object; and performing rendering processing on the effect guide map to obtain and display a target effect picture of the target effect, wherein the target effect picture comprises the filamentous object formed after the key guide line is rendered.

### CROSS REFERENCE TO RELATED APPLICATIONS

The present disclosure claims a priority right to the Chinese patent application No. 202211314027.9 filed on Oct. 25, 2022, the entire disclosure of which is hereby incorporated by reference in its entirety.

### FIELD

Embodiments of the present disclosure relate to effect processing technologies, and particularly to an effect processing method and apparatus, an electronic device, and a storage medium.

### BACKGROUND

In contemporary society, more and more users display images with image effects to display image content vividly through image effects, improve the representing capabilities of the images, and make the images more vivid.

In practical application, it is relatively difficult to render filamentous objects such as hair in real time due to limitations of characteristics of hair such as a large amount and a small size. A conventional multi-facet rendering method employed in the prior art needs to ensure that the distance between the multiple facets is close enough.

However, the conventional rendering method has the following problems: the calculation amount in hair rendering is huge, and it is very difficult to realize the effective rendering of long-hair effects due to the performance limitations, which reduces the hair-rendering performance; meanwhile, due to the relative diversification of the growth morphology and materials of hair, the production cost is high and any design effect is difficult to achieve; in addition, the rendering means is coarse, fine rendering of effect materials cannot be achieved, and the rendering effect is reduced.

### SUMMARY

Embodiments of the present disclosure provide an effect processing method and apparatus, an electronic device, and a storage medium, to achieve quick and fine rendering of a filamentous object in an effect.

In a first aspect, embodiments of the present disclosure provide an effect processing method, comprising:
responding to an effect trigger operation for a target effect;
when filamentous object rendering occurs in an effect subject corresponding to the target effect, determining an effect guide map of the effect subject, the effect guide map comprising a basic model of the effect subject and a key guide line representing a filamentous object;
performing rendering processing on the effect guide map to obtain and display a target effect picture of the target effect, wherein the target effect picture comprises the filamentous object formed after the key guide line is rendered.

In a second aspect, embodiments of the present disclosure provide an effect processing apparatus, comprising:
a responding module configured to respond to an effect trigger operation for a target effect;
a guide map determining module configured to, when filamentous object rendering occurs in an effect subject corresponding to the target effect, determine an effect guide map of the effect subject, the effect guide map comprising a basic model of the effect subject and a key guide line representing a filamentous object;
a processing and displaying module configured to perform rendering processing on the effect guide map to obtain and display a target effect picture of the target effect, wherein the target effect picture comprises the filamentous object formed after the key guide line is rendered.

In a third aspect, embodiments of the present disclosure further provide an electronic device, comprising:
one or more processors;
a storage device for storing one or more programs,
the one or more programs, when executed by the one or more processors, cause the one or more processors to implement the effect processing method as described in any one of the embodiments of the present disclosure.

In a fourth aspect, embodiments of the present disclosure further provide a storage medium containing computer-executable instructions, wherein the computer-executable instructions, when executed by a computer processor, are used to implement the effect processing method as described in any one of the embodiments of the present disclosure.

In the technical solutions of the embodiments of the present disclosure, firstly, a response is made to the effect trigger operation for the target effect; when filamentous object rendering occurs in the effect subject corresponding to the target effect, an effect guide map of the effect subject is determined, wherein the effect guide map comprises a basic model of the effect subject and a key guide line representing a filamentous object; and rendering processing is performed on the effect guide map to obtain and display a target effect picture of the target effect, wherein the target effect picture comprises the filamentous object formed after the key guide line is rendered. In the technical solution of the embodiment of the present disclosure, the effect guide map is introduced; when the triggered effect includes the filamentous object rendering, the effect guide map including the basic model information of the effect subject and the key information of the filamentous object may be first determined as the rough rendering of the effect, and subsequently rendering may be directly performed on the effect guide map to obtain the target effect picture achieving the precise rendering on the filamentous effect.

Different from the achievement of the rendering of the filamentous object in the effect in the prior art, the above technical solution simplifies the rendering of the filamentous object as the precise rendering performed based on the key guide line of the filamentous object, effectively reduces the computing amount in the rendering and ensures the rendering speed of the filamentous object while ensuring the rendering precision of the filamentous object; meanwhile, the filamentous object rendering in the present technical solution mainly depends on including the effect guide map characterizing the key guide line of the filamentous object, the process of the determining the effect guide map is simple and easy to implement, which also effectively reduces the production cost in designing the filamentous object and reduces the difficulty in achieving diversified design of the filamentous object.

### BRIEF DESCRIPTION OF THE DRAWINGS

The above and other features, advantages and aspects of the embodiments of the present disclosure will be more apparent in conjunction with the drawings and with reference to the following embodiments. The same or similar reference numerals throughout the drawings represent the same or similar elements. It should be understood that the drawings are schematic and the components and elements are unnecessarily drawn to scale.

FIG. 1 is a schematic flowchart of an effect processing method according to an embodiment of the present disclosure;

FIG. 2a is a diagram presenting an example of an effect resulting from an effect subject containing rough rendering information in an effect processing method according to an embodiment of the present disclosure;

FIG. 2b is a diagram presenting an example of an effect of rendering a basic model and a key guide line of an effect subject in an effect processing method according to an embodiment of the present disclosure;

FIG. 2c is an exemplary diagram of a target effect picture of an effect subject in an effect processing method according to an embodiment of the present disclosure;

FIG. 3 is a schematic flowchart of another effect processing method according to an embodiment of the present disclosure;

FIG. 4 is a structural schematic diagram of an effect processing apparatus according to an embodiment of the present disclosure;

FIG. 5 is a structural schematic diagram of an electronic device according to an embodiment of the present disclosure.

### DETAILED DESCRIPTION OF EMBODIMENTS

Embodiments of the present disclosure will be described in detail below with reference to the accompanying drawings. Although the drawings show some embodiments of the present disclosure, it should be understood that the present disclosure can be implemented in various forms and should not be construed as being limited to the embodiments described herein. Instead, the embodiments are provided for a more thorough and complete understanding of the present disclosure. It should be understood that the drawings and the embodiments in the present disclosure are for illustrative purpose only, and are not intended to limit the protection scope of the present disclosure.

It should be understood that the steps of the method according to the embodiments of the present disclosure may be performed in different orders, and/or be performed in parallel. In addition, the method embodiments may include additional steps and/or the performance of illustrated steps may be omitted. The scope of the present disclosure is not limited in this regard.

The term “including” and variants thereof as used herein are open-ended comprises, that is, “including but not limited to”. The term “based on” means “based at least in part on.” The term “an embodiment” means “at least one embodiment”, the term “another embodiment” means “at least one another embodiment”, and the term “some embodiments” means “at least some embodiments”. Definitions of other terms are provided in the following description.

It should be noted that the concepts such as “first” and “second” mentioned in the present disclosure are used to distinguish different apparatus, modules or units, and are not used to limit a sequential order or interdependence of the functions performed by the apparatus, modules or units.

It should be noted that, the modifications such as “one” and “a plurality of” mentioned in the present disclosure are schematic rather than restrictive, and should be understood as “one or more” by those skilled in the art, otherwise explicitly illustrated in the context.

The names of messages or information exchanged between a plurality of apparatuses in the embodiments of the present disclosure are only for illustrative purposes, and are not intended to limit the scope of the messages or information.

It may be appreciated that prior to using the technical solutions disclosed in various embodiments of the present disclosure, a user should be notified of the type, scope of use, use scenario, etc. of personal information involved in the present disclosure and authorization be obtained from the user in an appropriate manner according to relevant laws and regulations.

For example, in response to reception of the user's active request, prompt information is sent to the user to explicitly prompt the user that an operation he requests to perform needs to obtain and use the user's personal information. Accordingly, the user may autonomously select, according to the prompt information, whether to provide the personal information to software or hardware such as an electronic device, an application, a server or a storage medium, which executes the operation of the technical solution of the present disclosure.

As an alternative but non-limiting implementation, in response to reception of the user's active request, the prompt message may be sent to the user, for example, in the form of a pop-up window in which the prompt information may be presented in a text. In addition, the pop-up window may further carry a selection control for the user to select “agree” or “disagree” to provide the personal information to the electronic device.

It is to be understood that the above-described processes of notifying and obtaining the user's authorization are merely illustrative and not be construed as limiting the implementations of the present disclosure, and that other ways of satisfying relevant laws and regulations may also be applied to the implementations of the present disclosure.

It may be appreciated that the data (including but not limited to the data itself, acquisition or use of the data) involved in the technical solutions shall meet requirements of corresponding laws, regulations and relevant provisions.

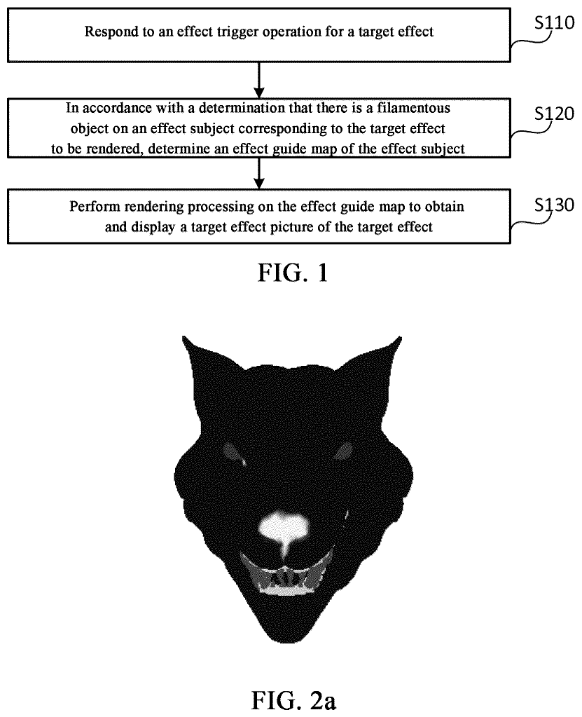

FIG. 1 is a schematic flowchart of a specific processing method according to an embodiment of the present disclosure. Embodiments of the present disclosure are applicable to situations where there is effect processing rendering of a filamentous object. The method may be performed by an effect processing apparatus, which may be implemented in the form of software and/or hardware, optionally an electronic device. The electronic device may be a mobile terminal, a Personal Computer (PC) terminal or a server, etc.

As shown in FIG. 1, the method according to the embodiment of the present disclosure may specifically comprise:
S110: responding to an effect trigger operation for a target effect.

It can be clear that more and more users display images with image effects to display image content vividly through image effects, improve the representing capabilities of the images, and make the images more vivid. The effect rendering method may be integrated in an electronic device such as a mobile terminal and a PC end, and the electronic device may display an effect picture accordingly upon receiving an effect trigger operation. The effect trigger operation may be understood as an operation for activating the function of effect processing after triggering. The target effect may be understood as an effect to be applied. Preferably, the effect picture in the present embodiment is a three-dimensional image effect. Alternatively, the target effect may be an effect to be applied and including an effect subject.

In an embodiment of the present disclosure, before responding to the effect processing operation, the method further comprises: receiving the effect trigger operation for the target effect. There may be many ways of triggering the effect trigger operation. Optionally, the receiving the effect trigger operation may include, but is not limited to: receiving an effect trigger operation acting on a pre-set effect trigger control, wherein the effect trigger control may be a virtual control element arranged on an application interface, for example, the virtual control element at least comprises at least one of an effect trigger button, an effect trigger selection menu and an effect trigger slider; or receiving sound information collected based on a sound collection device for enabling the effect; or receiving action information (such as hand action information, head action information or limb action information) for enabling the effect; or receiving an effect enable command for enabling the effect.

Specifically, in response to the effect trigger operation for the target effect, an effect subject to which the target effect is to be applied is determined. Exemplarily, if the presentation of an effect picture of a wolf is to be achieved, the effect picture of the wolf may be taken as the target effect.
S120: when filamentous object rendering occurs in an effect subject corresponding to the target effect, determining an effect guide map of the effect subject, wherein the effect guide map comprises a basic model of the effect subject and a key guide line representing the filamentous object.

In practical application, some target effects include hair; it is relatively difficult to render a filamentous object such as hair in real time due to limitations of characteristics of hair such as a large amount and a small size. The technical solution according to the present embodiment is mainly used to realize how to perform fine rendering on the filamentous object so as to obtain the effect picture of the target effect.

In this embodiment, the target effect needs to be determined first, and what the effect to be presented is on earth like is determined according to the received effect trigger operation for the target effect, wherein the effect should include information such as the effect subject. When the effect trigger operation is performed, what effect picture to be presented may be known, i.e., there is a pre-judgement for the target effect. It may be extracted based on the pre-judgement that to achieve the pre-judgement, it is necessary to firstly make clear what the effect subject is. After the effect subject is determined, it may be determined that the effect subject is to be displayed in the form of the target effect. Likewise, when the effect subject is presented with the target effect, it may be determined what objects are included in the displayed object, and whether the objects include filamentous objects.

The effect subject may be understood as an object on which the target effect acts herein. The target effect should have one effect subject which is to be achieved or whose effect is to be displayed. In other words, the target effect may include, but is not limited to including the effect subject. The target effect may further include other effect elements in addition to the effect subject. Whether the filamentous object for forming the effect subject exists in the target effect.

It needs to be appreciated that the embodiments of the present disclosure do not limit the specific content of the target effect as long as the target effect comprises the effect subject, and the effect subject comprises the filamentous object. Exemplarily, the target effect may be an effect of virtual hair comprising a plurality of hair filaments, an effect of a duster formed by a plurality of duster filaments or an effect of a tassels formed by a plurality of silk filaments. Alternatively, the filamentous object is hair.

It needs to be appreciated that after responding to the effect trigger operation for the target effect, determination further needs to be made as to whether the filamentous object rendering occurs on the effect subject. When a need for the filamentous object rendering exists, an effect guide map of the effect subject needs to be determined. Exemplarily, if the picture after the rendering is desired to present a vivid 3D rendering map of a wolf, a final effect to be achieved may be understood as the target effect, wherein the wolf may be taken as the effect subject corresponding to the target effect, the hair of the wolf may be understood as the filamentous object existing in the effect subject to be rendered, and it may be believed that the filamentous object rendering exists in the effect subject corresponding to the target effect.

In the present embodiment, the effect guide map comprises a basic model of the effect subject and a key guide line characterizing the filamentous object. The basic model of the effect subject may be understood as a model of the effect subject obtained by characterizing basic parameters of the effect subject, for example, the basic model may include the outline, structure, etc. of the effect subject. Since the rendering of the filamentous object exists in the effect subject, the key guide line charactering the filamentous object needs to be present. Exemplarily, the key guide line may be understood as a guide line obtained by performing rough rendering of key hair, lines etc. of the effect subject. In the case where the basic model and the key guide line are obtained, rough rendering may be performed on the basic model in conjunction with the rendering parameters on this basis to obtain the effect guide map. The effect guide map is obtained by performing rough rendering on the effect subject according to the basic model and key guide line and the rendering parameters pre-configured for the effect subject.

A process of generating the effect guide map of the effect subject is equivalent to a process of performing rough rendering on the effect subject, and the effect guide map may be obtained by performing the rough rendering on the effect subject. It needs to be appreciated that when the effect trigger operation is received, rough rendering can be performed on the effect subject quickly and in real time on the terminal device to quickly obtain the effect guide map. In the present embodiment, when a demand for the filamentous object rendering exists in the target effect, the effect guide map may be input into a pre-trained filamentous object rendering mode, and the target effect picture may be output. Before being input into the model, the effect guide map needs to be obtained as input information. The effect guide map comprises a hair guide map and a division guide map. The hair guide map may be obtained according to duly preset hair key guide line information in conjunction with the basic model. The division guide map may be obtained based on a deformation parameter, an optical parameter and a simulation parameter in conjunction with the basic model. Exemplarily, assuming the effect subject is a wolf, the deformation parameter may be large opening of the mouth or large opening of eyes of the effect subject. The hair guide map and the division guide map jointly constitute the effect guide map as the input information of the model.

In the present embodiment, when the terminal device performs the effect rendering, the 3D basic model of the effect subject can be obtained from a material repository. For example, to achieve real rendering of the wolf, a 3D model of the wolf needs to be obtained first; simple materials such as information of some lines are combined on the premise of the 3D model of the wolf, and then the hair guide map is formed after performing rendering on the line information and the 3D model. Likewise, the division map refers to a map presenting different regional features such as the eyes, outline and teeth in different colors and forms after the most basic model is obtained. The map is referred to as the division guide map. The division guide map is obtained by performing rendering on the basic model based on some parameters. After the 3D model is obtained, the division guide map may be formed by combining these deformation parameters with the 3D model according to other parameter information such as positions of teeth and presentation forms of the teeth. Assuming a picture of a wolf with the mouth open is to be formed, the model might be a model of the wolf with the mouth closed, the deformation parameters of the wolf with the mouth open are given to the 3D model, the model is adjusted through these deformation parameters to present the wolf in a form of an open mouth, and the formed map may be taken as the division guide map.

Alternatively, after the effect trigger operation for the target effect is received, it is necessary to determine the effect subject corresponding to the target effect, and further determine whether the filamentous object rendering occurs in the effect subject. If the filamentous object rendering occurs in the effect subject corresponding to the target effect, rough rendering is performed according to parameter information, the basic model etc. to determine the effect guide map of the effect subject.

S130: performing rendering processing on the effect guide map to obtain and display a target effect picture of the target effect, wherein the target effect picture comprises the filamentous object formed after the key guide line is rendered.

In the present embodiment, the step is equivalent to performing precise rendering on the effect subject on the basis of the effect guide map. The original effect guide map already includes the basic model and the key guide line information. Based on this, the filamentous object is enriched to specifically reflect the rendering on the effect subject with a larger amount of denser and finer hair lines. The effect guide may be understood as an image obtained by performing rough rendering on the basic model according to the key guide line information. The target effect picture may be understood as including the filamentous object formed by performing further precise rendering on the key guide line of the effect subject on the basis of the effect guide map. Exemplarily, the effect guide map may reflect a display color, a display form and a display position of the effect subject and the key guide line characterizing the filamentous object. Performing further rendering on the effect guide map may be understood as further rendering the key guide line to make the key guide line richer and denser.

Exemplarily, one implementation of performing rendering processing on the effect guide map to obtain the target effect picture of the target effect may be: based on the pre-trained filamentous object rendering model, inputting the effect guide map into the filamentous object rendering model, and outputting the target effect picture. When there is a need to render the filamentous object in the target effect, in order to render quickly and in real time to get the effect picture in a short rendering time and with a good rendering effect, a manner of achieving a very good rendering effect originally in an offline manner is embodied in the form of a model, the model is constantly trained to obtain a model capable of achieving rendering very vividly, and the model is directly applied to the terminal.

Exemplarily, when there is a need for filamentous object rendering, a desired effect picture may be obtained by inputting some information directly into the duly trained model. In the present embodiment, the trained model may be a neural network model, which needs to be obtained by training in advance, and the trained neural network model is taken as the filamentous object rendering model. In the present embodiment, the specific model structure and training manner of the filamentous object rendering model are not specifically limited. It may be appreciated that objects other than filamentous object in the effect picture may be directly embodied in the effect guide map, and the filamentous object needs to be embodied more vividly in combination with the filamentous object rendering model. After the target effect picture is obtained, the target effect picture may be displayed.

In the technical solution of the embodiment of the present disclosure, firstly, a response is made to the effect trigger operation for the target effect; when filamentous object rendering occurs in the effect subject corresponding to the target effect, an effect guide map of the effect subject is determined, wherein the effect guide map comprises a basic model of the effect subject and a key guide line representing a filamentous object; and rendering processing is performed on the effect guide map to obtain and display a target effect picture of the target effect, wherein the target effect picture comprises the filamentous object formed after the key guide line is rendered. In the technical solution of the embodiment of the present disclosure, the effect guide map is introduced; when the triggered effect includes the filamentous object rendering, the effect guide map including the basic model information of the effect subject and the key information of the filamentous object may be first determined as the rough rendering of the effect, and subsequently rendering may be directly performed on the effect guide map to obtain the target effect picture achieving the precise rendering on the filamentous effect. Different from the achievement of the rendering of the filamentous object in the effect in the prior art, the above technical solution simplifies the rendering of the filamentous object as the precise rendering performed based on the key guide line of the filamentous object, effectively reduces the computing amount in the rendering and ensures the rendering speed of the filamentous object while ensuring the rendering precision of the filamentous object; meanwhile, the filamentous object rendering in the present technical solution mainly depends on including the effect guide map characterizing the key guide line of the filamentous object, the process of the determining the effect guide map is simple and easy to implement, which also effectively reduces the production cost in designing the filamentous object and reduces the difficulty in achieving diversified design of the filamentous object.

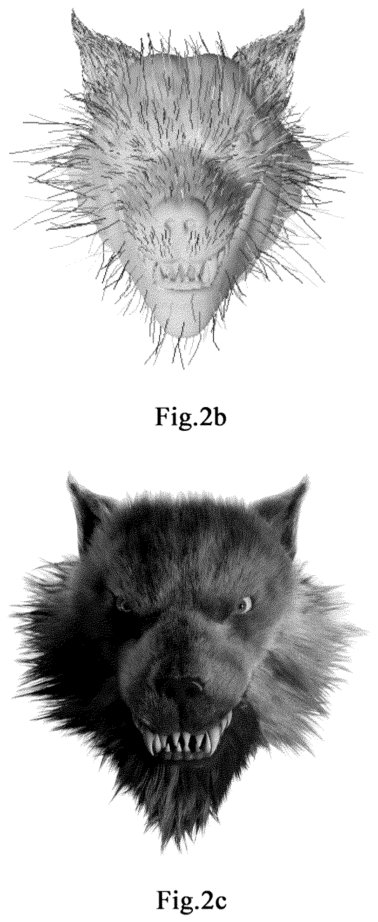

Exemplarily, a specific implementation of the effect processing method will be described below to illustrate the effect processing method according to the embodiment of the present disclosure more clearly. FIG. 2a is a diagram presenting an example of an effect resulting from an effect subject containing rough rendering information in an effect processing method according to an embodiment of the present disclosure. As shown in FIG. 2a, FIG. 2a shows a rough rendering presenting effect of a wolf as the effect subject, mainly embodied in the presentation of morphology parameters such as the rendering of the contour and the eye-opening state of the effect subject, and rough rendering information such as the outline of teeth and nose shape.

FIG. 2b is a diagram presenting an example of an effect of rendering a basic model and a key guide line of an effect subject in an effect processing method according to an embodiment of the present disclosure.

As shown in FIG. 2b, the diagram includes an effect diagram constituted by the basic model and key guide line of the effect subject, and it can be believed that the effect diagram may be formed in conjunction with the rendering of the basic model and the key guide line. The diagram mainly includes the key guide line information, specifically embodied as information such as the position, length and shape of the key guide line. An effect guide map may be obtained by performing preliminary rendering in conjunction with the relevant information included and shown in FIGS. 2a and 2b.

FIG. 2c is an exemplary diagram of a target effect picture of an effect subject in an effect processing method according to an embodiment of the present disclosure. FIG. 2c shows a diagram presenting an effect achieved by performing further rendering processing on the basis of the specific effect guide map. It can be seen that the finally-formed effect picture not only includes effect such as morphology and hair of the effect subject, but also enriches the hair. The hair is dense and diversified, and the presented effect is more vivid.

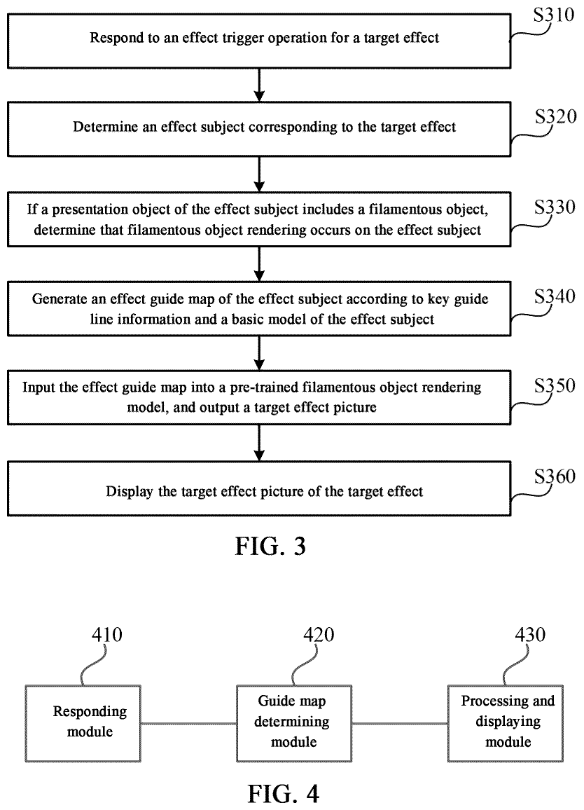

FIG. 3 is a flowchart of another effect processing method according to an embodiment of the present disclosure. The embodiment of the present disclosure further describes a step of determining the effect guide map of the effect subject and a step of determining the target effect picture. As shown in FIG. 3, the method comprises:
S310: responding to an effect trigger operation for a target effect.
S320: determining an effect subject corresponding to the target effect.

In the present embodiment, the target effect needs to be determined first, and what the effect to be presented is on earth like is determined according to the received effect trigger operation for the target effect, wherein the effect should include information such as the effect subject. When the effect trigger operation is performed, what effect picture to be presented may be known, i.e., there is a pre-judgement for the target effect. It may be extracted based on the pre-judgement that to achieve the pre-judgement, it is necessary to firstly make clear what the effect subject is. After the effect subject is determined, it may be determined that the effect subject is to be displayed in the form of the target effect.
S330: if a presentation object of the effect subject includes a filamentous object, determining that filamentous object rendering occurs on the effect subject.

In this step, when the effect subject is presented with the target effect, it needs to be determined what objects are included in the displayed object, and whether the objects include filamentous objects. Exemplarily, if the effect subject is a wolf, the current morphology presented by the wolf as the effect subject, such as opening the mouth and opening eyes, may be determined. In addition, when it is determined that the effect subject is the wolf, it is clearly known that material attributes configured for the wolf include hair as one item. That is to say, when the target effect corresponding to the effect subject is to be presented, whether the displayed effect includes the filamentous object as one effect is known. When an effect includes the filamentous object as an effect, it is determined that the filamentous object rendering occurs on the effect subject, i.e., a demand for effect rendering occurs on the effect subject.
S340: generating an effect guide map of the effect subject according to key guide line information and a basic model of the effect subject, the key guide line information comprising a position and/or length of the key guide line.

In the present embodiment, when it is determined that the filamentous object rendering occurs on the effect subject, i.e., when a demand for filamentous object rendering occurs, the effect guide map of the effect subject needs to be generated according to the key guide line information and basic model of the effect subject. The key guide line information and basic model need to be obtained in order to obtain the effect guide map. The basic model refers to a model for presenting in a 3D form when different effect subjects are rendered. A basic 3D model is needed here. The key guide line information means that if filamentous rendering is subsequently needed, it is necessary to obtain basic or key guide line information as basic filamentous information of the filamentous rendering, i.e., information of lines. The key guide line information may comprise a presentation length of the filamentous object, position information presented on the effect subject, etc. The effect guide map may be understood as an image obtained by performing rough rendering for the basic model according to the guide line information, and may reflect information such as a display color, a display form and a display position of the effect subject.

Furthermore, the generating an effect guide map of the effect subject according to a basic model and key guide line information of the effect subject comprises:
a1) obtaining a basic model of the effect subject for 3D modeling, and extracting key guide line information and rough rendering parameters preset with respect to the effect subject.

It may be appreciated that the effect guide map is an image obtained from rough rendering, and that it is necessary to first obtain the basic model of the effect subject for 3D modeling and rough rendering parameters in order to generate the effect guide map of the effect subject. The rough rendering parameters comprise the key guide line information, and attribute-related rough rendering parameters such as material parameters, deformation parameters and illumination parameters. The key guide line information may comprise a presentation length of lines, position information presented on the effect subject, etc. The specific content of extracting the key guide line information, rough rendering parameters and the basic model is related to an application scenario to be actually presented. For example, if the mobile terminal or user terminal desires to present the effect, the parameters needed before the presentation of the effect are obtained in a design phase, or in an effect material collecting or creating phase, and the information may be pre-stored as known information. After the target effect and the effect subject are obtained, data information needed for this effect may be obtained.
b1) performing tile rendering for the basic model through the rough rendering parameters and key guide line information, to obtain the effect guide map of the effect subject.

Specifically, after the above parameters are obtained, these parameters may be rendered on the basic model in the form of tiles. A division guide map may be obtained according to the rough rendering parameters and the basic model. For example, if there is a deformation in the rough rendering, adjustment of the model position may be achieved based on position information of the deformation. A hair guide map may be obtained according to the key guide line information and the basic model. The hair guide map may be understood as including an image obtained by performing preliminary rough rendering for the filamentous object. The division guide map and hair guide map are combined as the effect guide map of the effect subject.

The above technical solution specifies the step of generating the effect guide map of the effect subject according to the basic model and key guide line information of the effect subject. When it is determined there is a demand for filamentous object rendering, the basic model of the effect subject for 3D modeling is first obtained, and the key guide line information and rough rendering parameters of the effect subject are extracted; then the tile rendering is performed for the basic model through the rough rendering parameters and key guide line information to obtain the effect guide map of the effect subject. The division guide map is obtained by performing tile rendering for the basic model through the rough rendering parameters, the hair guide map is obtained by performing the tile rendering for the basic model through the key guide line information, the rendering effect of the effect guide map obtained by fusing the division guide map and the hair guide map is better, the guide line in conjunction with an illumination white model and in conjunction with a semantic division map is taken as input to the model, the key guide line information may be taken as supervision information for guiding the basic model to generate hair filaments, the illumination white model may introduce information about illumination and outline, and the semantic division map may enhance the generating effect of edges and details. The more vivid representation of the filamentous object is achieved based on the filamentous object rendering model. Hair shake and illumination transformation based on physical simulation are supported. As compared with the guide map obtained in other manners, the rendering quality of the effect guide map is better, and the effect is more vivid in the present technical solution. A more precise input image is provided for subsequent rendering of the target effect picture.

S350: inputting the effect guide map into a pre-trained filamentous object rendering model, and outputting a target effect picture, the filamentous object rendering model being obtained by training through a predetermined guide map-rendering map sample image pair.

In the present embodiment, when there is a need to render the filamentous object in the target effect, in order to render quickly and in real time to get the effect picture in a short rendering time and with a good rendering effect, a manner of achieving a very good rendering effect originally in an offline manner is embodied in the form of a model, the model is constantly trained to obtain a model capable of achieving rendering very vividly, and the model is directly applied to the terminal. When there is a need to render the filamentous object, a desired effect picture may be obtained by inputting some information directly into the duly-trained model. In the present embodiment, the trained model may be a neural network model and needs to be obtained by training in advance, and the trained neural network is taken as the filamentous object rendering model.

It needs to be appreciated that the filamentous object rendering model is obtained by training through a predetermined guide map-rendering map sample image pair. The guide map-rendering map sample image pair comprises a guide map sample and a rendering map sample. The rendering map sample may be understood as a vivid map. The filamentous object rendering model may be obtained by inputting the guide map sample into the neural network model in conjunction with the rendering map sample. In the present embodiment, the manner of training the filamentous object rendering model is not specifically limited. It may be appreciated that other objects in the effect picture in addition to the filamentous object may be embodied directly in the effect guide map, and the filamentous object needs to be embodied more vividly in conjunction with the filamentous object rendering model.

S360: displaying the target effect picture of the target effect.

Specifically, the target effect picture of the target effect generated in the previous step is displayed.

In the embodiment of the present disclosure, the step of determining the effect guide map of the effect subject is specified. When the effect trigger operation for the target effect is received, the effect subject corresponding to the target effect is determined, and then whether the object presented on the effect subject include the filamentous object is determined. If YES, it may be determined that a demand for filamentous object rendering exists on the effect subject, and then the effect guide map of the effect subject is generated according to the key guide line information and basic model of the effect subject. The technical solution according to the present embodiment may quickly achieve the rendering of the effect guide map and improve a real-time property of the effect rendering.

As an optional embodiment of the embodiment of the present disclosure, on the basis of the above embodiment, further optimizing the step of training the filamentous object rendering model comprises:
a2) building an initial conditional generative adversarial network model which comprises a generator and a multi-scale discriminator.

In the present embodiment, what is used upon training the filamentous object rendering model by using the adversarial network idea is the conditional generative adversarial network idea. The initial conditional generative adversarial network model is built first. The initial conditional generative adversarial network model comprises a generator and a discriminator. The generator is capable of generating a map based on some already-existing information, and the discriminator judges whether the map is a true map or a false map. The parameters of the generator are adjusted through a discrimination result to make the output result of the generator more and more vivid. Adjusting the parameters of the discriminator constantly can cause the input map to be judged false more and more precisely.

It may be appreciated that the conditional generative adversarial network model in the step is an improved model, and its input information is not multi-dimensional numbers but images. In the present embodiment, training is performed using a discriminator for image translation. A policy employed by the discriminator for image translation is to solve low-frequency components by re-building, whereas the generative adversarial network is used to solve high-frequency components. On the one hand, a conventional loss value is used to make the generated picture approximate as much as possible to the trained picture, and the generative adversarial network is used to build details of the high-frequency portions. Its idea is that since the generative adversarial network is only used for building the high-frequency information, it is unnecessary to input the whole piece of picture into the discriminator; clipping is first randomly performed within the range of the picture to obtain several picture pieces in different sizes, and the discriminator judges whether the picture is true or false.

In the present discriminator, the multi-scale discriminator is employed, and built based on three scales. The discriminators with three scales are respectively an independent discriminator, and jointly constitute the multi-scale discriminator. The multi-scale discriminator may be understood as discriminating three times. The original picture, before being input to the discriminator, is first randomly clipped with the range of the picture to obtain several picture pieces in different sizes. Three discriminators with the number of layers being 3, 2, 1, respectively are maintained. The picture will be down sampled every time the picture is input into a discriminator with a fewer number of layers. Exemplarily, a down-sampling function is employed to down-sample the picture. The three-layer discriminator directly inputs the original picture, the 2-layer discriminator inputs a ½-sized picture, and the one-layer discriminator inputs a ¼-sized picture. The differently-sized pictures are input into the discriminators, the discriminator at each layer has one output, a mean value of output results corresponding to all sizes of one piece of picture is taken as an output result, and a corresponding loss value may be calculated. Exemplarily, the calculation of the loss value may be similar to the implementation of a swap encoder, which is not specifically limited herein.
b2) obtaining a training sample set comprising at one group of sample image pairs, each group of sample image pairs comprising a sample guide map and a sample rendering map.

In this step, the conditional generative adversarial network model is trained based on the training sample set. The conditional adversarial training sample set is not random. The sample images included in the training sample set comprise a sample guide map and a sample rendering map. The sample guide map and the sample rendering map in one sample image pair are rendered with respect to the same subject. The sample guide map and the sample rendering map may be understood as being obtained by performing rendering for the same subject to different degrees. The sample guide map is obtained from rough rendering. The sample rendering map is obtained by using other engine tools for fine rendering with a better effect. The sample rendering map may be understood as a true map.
c2) training the generator and the multi-scale discriminator according to the sample image pairs to obtain the filamentous object rendering model.

In this step, the sample image pair comprises the sample guide map and the sample rendering map, and the output result of the generator may be obtained by inputting the sample guide map into the generator. Then, the output result of the generator and the sample guide map and the sample rendering map are jointly taken as an input to the discriminator, and the parameters of the generator and discriminator are adjusted according to the output result of the discriminator, to achieve the training of the generator and discriminator so that the generator and discriminator satisfy requirements for the precision, and the generator satisfying the requirements for the precision after the training is taken as the filamentous object rendering model.

In the optional embodiment, the multi-scale discriminator is introduced on the basis of a structural similarity index loss and a generative adversarial network loss, and the discriminator is trained based on images at the above three types of scales to make the discriminator more precise. The representation of the details of hair is enhanced. Since the dimensionality of the input is greatly reduced, the number of parameters is small, the operation speed is faster than direct input of a piece of picture, and an image in any size may be calculated.

Furthermore, the step of training the generator and the multi-scale discriminator according to the sample image pairs to obtain the filamentous object rendering model may be expressed as:
c21) taking the sample guide map in the sample image pair as input data of the generator.

Specifically, the sample guide map in the sample image pair is taken as input data of the generator, and the generator may perform rendering for the sample guide map to obtain an output result of the generator.
c22) constituting two sets of input data of the multi-scale discriminator based on the output result of the generator, and the sample guide map and sample rendering map in the sample image pair.

Specifically, the output result of the generator and the sample guide map are taken as one set of data, and the sample rendering map of the sample image pair and the sample guide map are taken as the other set of data. The two sets of data jointly constitute the two sets of input data of the multi-scale discriminator, which are respectively input into the multi-scale discriminator.
c23) performing parameter adjustment for the generator and the multi-scale discriminator respectively according to an output result of the multi-scale discriminator with respect to the two set of input data, and in conjunction with a predetermined loss function.

Specifically, the above two sets of input data are taken as the input to the discriminator, there will be an output result after the operation, and these parameters can be adjusted according to the loss result of the loss function. It needs to be appreciated that the predetermined loss function can adjust the parameters of the generator and parameters of the multi-scale discriminator. The purpose of the adversarial idea in the conditional generative adversarial network model is to make the rendering map generated by the generator more approximate to the true map to allow the discriminator to discriminate whether the map is true or false more accurately. The predetermined loss function is applied to the generator and the discriminator. The targets achieved by the two are different, and the results achieved by the parameters are also different. In this step, a plurality of loss parameters are used to intervene to perform parameter adjustment.
c24) after a training iteration completion condition is satisfied, taking the trained generator as the filamentous object rendering model.

The iteration completion condition may be understood in a way that an output image obtained by inputting the information into the generator reaches a preset precision to obtain a vivid rendering image, a discrimination result of the discriminator into which the rendering image and the effect guide map are input reaches a preset precision, and authenticity of the rendering image can be discriminated precisely. If the generator and discriminator respectively reach the preset precision, the duly trained generator may be taken as the filamentous object rendering model for subsequent rendering of the filamentous object.

The present optional embodiment specifies the step of training the filamentous object rendering model. In a scenario of a high resolution network structure, group normalization is introduced, stability of the model representation is enhanced, and a flash phenomenon in hair rendering in the high-frequency scenario is reduced.

Furthermore, the generator is represented with a given first network structure, and the multi-scale discriminator is represented with a given second network structure; the loss function comprises: a generative adversarial loss function, a learning perceptual image patch similarity loss function and a random image patch loss function.

The high-resolution network structure proposed for a 2D human body posture estimation task is referred to as a HRNet structure, and a U-shaped network structure is referred to as a UNet structure. The first network structure may be either the HRNet structure or the UNet structure. The two types of different network structures are respectively employed in different scenarios. The two types of structures have different characteristics. The HRNet network exhibits a large calculation amount and a better effect, and is adapted for scenarios such as accelerated rendering instant interaction on a computer. The Hdnet structure exhibits a better-ensured relative complexity precision and better trueness, and is not very applicable for the mobile terminal. The UNet structure may be compressed to a smaller calculation amount and is applicable for deploying a real-time version on the mobile phone terminal.

In the present embodiment, the model employs an image translation mode. The mode is substantially the conditional generative adversarial network model. A specific principle is as follows: training a conditional generative adversarial network model to map an outline map to a picture. The discriminator learns to classify groups of false pictures (synthesized by the generator) and true pictures. The generator learns to deceive the discriminator. Different from the ordinary generative adversarial network model, the generator and discriminator both observe the input outline maps and the generated pictures or true pictures, whereas the ordinary generative adversarial network model directly inputs the generated pictures or true pictures.

The present optional embodiment specifies the step of training the filamentous object rendering model. The multi-scale discriminator is introduced on the basis of a structural similarity index loss and a generative adversarial network loss, and the discriminator is trained based on images at the above three types of scales to make the discriminator more precise. The representation of the details of hair is enhanced. In the HRNet scenario, group normalization is introduced, stability of the model representation is enhanced, and a flash phenomenon in hair rendering in the high-frequency scenario is reduced.

Alternatively, the sample guide map and sample rendering map in the sample image pair are determined by rendering respectively through a predetermined rendering engine tool based on the same rendering parameters.

In this step, more precise rendering is obtained by performing rendering on an offline rendering engine tool. The rendering parameters may comprise camera parameters, illumination parameters, physical parameters etc. To ensure consistency of rendering, the basic model needs to be rendered based on the same rendering parameters to obtain the sample guide map and the sample rendering map, respectively. With the same parameters being used, the presentation of attributes, morphology, light etc. should be ensured consistent, and the alignment of the sample guide map and sample rendering map is achieved. The sample guide map and sample rendering map corresponding to the same parameters form the sample image pair. Exemplarily, assuming that the wolf opens the mouth in the effect rendering of the wolf, the wolf also opens the mouth on the sample guide map and sample rendering map, and the opening morphology is the same.

Considering the precise rendering of the image is achieved in a relatively longer time and not achieved in real time, the step swaps the rendering effect with time, thereby obtaining a precise sample rendering map. Since the effect guide map may be generated quickly and in time, too much time is not taken up. It is feasible to directly obtain a target effect picture, achieve quick and real-time rendering of the filamentous object and improve the effect rendering performance by inputting the effect guide map directly into the pre-trained filamentous object rendering model.

Furthermore, the step of determining the sample guide map and the sample rendering map in the sample image pair comprises:
a3) obtaining a sample subject including the filamentous object and sample rendering parameters, the sample rendering parameters comprising camera parameters, illumination parameters and physical simulation deformation parameters.

Specifically, the sample subject including the filamentous object is found, and the sample rendering parameters are obtained. The sample rendering parameters comprise camera parameters, illumination parameters, physical simulation deformation parameters etc.
b3) performing tile rendering for a sample modeling model of the sample subject through sample key guide line information of the sample subject in conjunction with the sample rendering parameters, to obtain the sample guide map of the sample subject.

The sample guide map and sample rendering map in a sample image are obtained by performing rendering for the same sample subject with the same requirement. The two types of maps are presented in different forms, but the morphology attributes resulting from the rendering are the same. Specifically, tile rendering is performed for a sample modeling model of the sample subject through sample key guide line information of the sample subject in conjunction with the sample rendering parameters, to obtain a sample hair guide map and a sample division guide map which jointly constitute the sample guide map. The hair guide map mainly reflects characteristics of the filamentous object of the sample subject in the map. The division guide map presents content of the sample subject such as morphology, deformation, regional position, and light parameters.
c3) performing offline rendering for the sample modeling model on a given offline rendering engine tool through the sample rendering parameters, to obtain the sample rendering map of the sample subject.

The given offline rendering engine tool may be a rendering engine function. The offline rendering is performed for the sample modeling model through the sample rendering parameters, rendering is performed on the offline rendering engine tool, some parameters are configured on the offline rendering engine tool, and a truer and more vivid rendering map may be achieved based on the effect of the rendering on the tool, as the sample rendering map of the sample subject.

In the above technical solution, considering the precise rendering of the image is achieved in a relatively longer time and not achieved in real time, the step swaps the rendering effect with time, and generate an image by a conventional graphics rendering algorithm, thereby obtaining a precise sample rendering map. The sample image pair generated based on the technical solution is used to train a neural network model to obtain the filamentous object rendering model. The filamentous object rendering model may be directly applied to the terminal device, thereby achieving real-time filamentous object rendering function with a better rendering effect, and improving the performance of the effect rendering including the filamentous object.

FIG. 4 is a block diagram of an effect processing apparatus according to an embodiment of the present disclosure. As shown in FIG. 4, the apparatus comprises: a responding module 410, a guide map determining module 420 and a processing and displaying module 430.

The responding module 410 is configured to respond to an effect trigger operation for a target effect; the guide map determining module 420 is configured to, when filamentous object rendering occurs in an effect subject corresponding to the target effect, determine an effect guide map of the effect subject, the effect guide map comprising a basic model of the effect subject and a key guide line representing a filamentous object; the processing and displaying module 430 is configured to perform rendering processing on the effect guide map to obtain and display a target effect picture of the target effect, wherein the target effect picture comprises the filamentous object formed after the key guide line is rendered.

In the technical solution of the embodiment of the present disclosure, firstly, a response is made to the effect trigger operation for the target effect; when filamentous object rendering occurs in the effect subject corresponding to the target effect, an effect guide map of the effect subject is determined, the effect guide map comprising a basic model of the effect subject and a key guide line representing a filamentous object; then rendering processing is performed on the effect guide map to obtain and display a target effect picture of the target effect, wherein the target effect picture comprises the filamentous object formed after the key guide line is rendered. In the technical solution of the embodiment of the present disclosure, the effect guide map is introduced; when the triggered effect includes the filamentous object rendering, the effect guide map including the basic model information of the effect subject and the key information of the filamentous object may be first determined as the rough rendering of the effect, and subsequently rendering may be directly performed on the effect guide map to obtain the target effect picture achieving the precise rendering on the filamentous effect. Different from the achievement of the rendering of the filamentous object in the effect in the prior art, the above technical solution simplifies the rendering of the filamentous object as the precise rendering performed based on the key guide line of the filamentous object, effectively reduces the computing amount in the rendering and ensures the rendering speed of the filamentous object while ensuring the rendering precision of the filamentous object; meanwhile, the filamentous object rendering in the present technical solution mainly depends on including the effect guide map characterizing the key guide line of the filamentous object, the process of the determining the effect guide map is simple and easy to implement, which also effectively reduces the production cost in designing the filamentous object and reduces the difficulty in achieving diversified design of the filamentous object.

Optionally, the guide map determining module 420 specifically comprises:
a first determining unit configured to determine an effect subject corresponding to the target effect;
a second determining unit configured to, if a presentation object of the effect subject includes a filamentous object, that filamentous object rendering occurs on the effect subject;
a guide map generating unit configured to generate an effect guide map of the effect subject according to key guide line information and a basic model of the effect subject.

Optionally, the guide map generating unit is specifically configured to:
obtain a basic model of the effect subject for 3D modeling, and extract key guide line information and rough rendering parameters preset with respect to the effect subject;
perform tile rendering for the basic model through the rough rendering parameters and key guide line information, to obtain the effect guide map of the effect subject.

Optionally, the processing and displaying module 430 is specifically configured to:
input the effect guide map into a pre-trained filamentous object rendering model, and output a target effect picture, the filamentous object rendering model being obtained by training through a predetermined guide map-rendering map sample image pair;
display the target effect picture of the target effect.

Optionally, the apparatus further comprises a model training module specifically comprising:
an initial building unit configured to build an initial conditional generative adversarial network model which comprises a generator and a multi-scale discriminator;
a sample obtaining unit configured to obtain a training sample set comprising at one group of sample image pairs, each group of sample image pairs comprising a sample guide map and a sample rendering map;
a training unit configured to train the generator and the multi-scale discriminator according to the sample image pairs to obtain the filamentous object rendering model.

Optionally, the training unit is specifically configured to:
take the sample guide map in the sample image pair as input data of the generator;
constitute two sets of input data of the multi-scale discriminator based on an output result of the generator, and the sample guide map and sample rendering map in the sample image pair;
perform parameter adjustment for the generator and the multi-scale discriminator respectively according to an output result of the multi-scale discriminator with respect to the two set of input data, and in conjunction with a predetermined loss function;
after a training iteration completion condition is satisfied, take the trained generator as the filamentous object rendering model.

Optionally, the generator is represented with a given first network structure, and the multi-scale discriminator is represented with a given second network structure;

the loss function comprises: a generative adversarial loss function, a learning perceptual image patch similarity loss function and a random image patch loss function.

Optionally, the sample guide map and sample rendering map in the sample image pair are determined by rendering respectively through a predetermined rendering engine tool based on the same rendering parameters.

Optionally, the filamentous object is hair.

The effect processing apparatus according to the embodiment of the present disclosure may perform the effect processing method according to any embodiment of the present disclosure, and has functional modules for performing steps of the method and resultant technical effects.

It should be noted that the various units and modules included in the above apparatus are merely divided according to functional logic, but are not limited to the above division as long as corresponding functions can be realized; in addition, the specific names of the functional units are only intended to facilitate distinguishing from one another and not to limit the protection scope of the embodiments of the present disclosure.

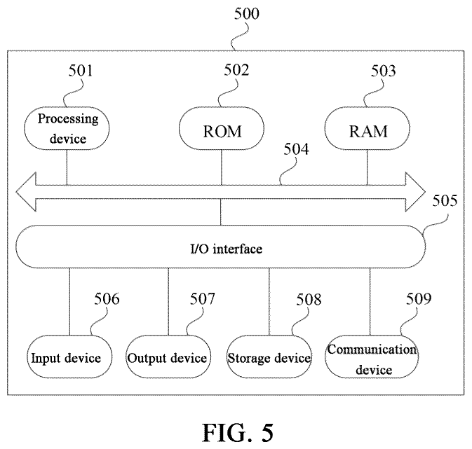

FIG. 5 is a structural schematic diagram of an electronic device according to an embodiment of the present disclosure. Reference is made below to FIG. 5 which shows a structural schematic diagram of an electronic device (e.g., a terminal device or a server in FIG. 5) adapted to implement the embodiments of the present disclosure. The terminal device in the embodiments of the present disclosure may comprise, but not limited to, mobile terminals such as mobile phones, notebook computers, digital broadcast receivers, Personal Digital Assistants (PDAs), Portable Android Devices (PADs), Portable Multimedia Players (PMPs), in-vehicle terminals (e.g., in-vehicle navigation terminals), etc. and fixed terminals such as digital TVs, desktop computers, etc. The electronic device shown in FIG. 5 is merely an example and should not impose any limitations on the functionality and scope of use of embodiments of the present disclosure.

As shown in FIG. 5, the electronic device 500 may comprise a processing device (e.g., a central processing unit, a graph processor, etc.) 501 that may perform various suitable acts and processes in accordance with a program stored in a Read Only Memory (ROM) 502 or a program loaded from a storage device 505 into a Random Access Memory (RAM) 503. In the RAM 503, various programs and data needed by the operation of the electronic device 500 are also stored. The processing device 501, the ROM 502, and the RAM 503 are connected to one another via a bus 504. An input/output (I/O) interface 505 is also coupled to bus 504.

In general, the following devices may be connected to the I/O interface 505: an input device 506 including, for example, a touch screen, a touch pad, a keyboard, a mouse, a camera, a microphone, an accelerometer, a gyroscope, etc.; an output device 507 including, for example, a Liquid Crystal Display (LCD), a speaker, a vibrator, etc.; a storage device 508 including, for example, a magnetic tape, a hard disk, etc.; and a communication device 509. The communication device 509 may allow the electronic device 500 to communicate in a wireless or wired manner with other devices to exchange data. While FIG. 5 illustrates the electronic device 500 having various devices, it is to be understood that not all illustrated device are required to be implemented or provided. More or fewer devices may alternatively be implemented or provided.

According to embodiments of the present disclosure, the processes described above with reference to flow charts may be implemented as computer software programs. For example, embodiments of the present disclosure comprise a computer program product comprising a computer program carried on a non-transitory computer-readable medium, the computer program comprising program code for performing the method illustrated by the flow charts. In such embodiments, the computer program may be downloaded and installed from a network via the communication device 509, or installed from the storage device 508, or installed from the ROM 502. When the computer program is executed by the processing device 501, the above-described functions defined in the method of the embodiment of the present disclosure are performed.

The names of messages or information interacted between devices in embodiments of the present disclosure are for illustrative purposes only and are not intended to limit the scope of such messages or information.

The electronic device according to the present embodiment of the present disclosure and the effect processing method according to the above embodiments belong to the same inventive concept, and technical details not described in detail in the present embodiment may be found from the above-mentioned embodiments, and the present embodiments have the same advantageous effects as the above-mentioned embodiments.

Embodiments of the present disclosure provide a computer storage medium having stored thereon a computer program that, when executed by a processor, implements the effect processing method according to the above embodiments.

It is appreciated that the computer-readable medium described above in the present disclosure may be either a computer-readable signal medium or a computer-readable storage medium, or any combination of the two. The computer-readable storage medium may be, for example but not limited to, an electronic, magnetic, optical, electromagnetic, infrared, or semiconductor system, apparatus, or device, or a combination of any of the above. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device. In the present disclosure, the computer-readable signal medium may comprise an information signal embodied in baseband or propagated as part of a carrier carrying computer-readable program code. Such propagated information signals may take many forms, including but not limited to, electromagnetic signals, optical signals, or any suitable combinations thereof. The computer-readable signal medium may also be any computer-readable medium other than a computer-readable storage medium that may send, propagate, or transport the program for use by or for use in conjunction with the instruction execution system, apparatus, or device. The program code contained on the computer-readable medium may be transmitted with any suitable medium including, but not limited to: electrical wire, optic cable, RF (radio frequency), and the like, or any suitable combinations thereof.

In some embodiments, the client and server may communicate using any currently known or future-developed network protocol, such as HTTP (HyperText Transfer Protocol), and may be interconnected with any form or medium of digital data communication (e.g., a communication network). Examples of the communication network comprise Local Area Networks (“LANs”), Wide Area Networks (“WANs”), the Internet, and peer-to-peer networks (e.g., ad hoc peer-to-peer networks), as well as any currently known or future-developed networks.

The computer readable medium may be contained in the above-described electronic device; it may also be present separately and not installed into the electronic device.

The computer-readable medium carries one or more programs that, when executed by the electronic device, cause the electronic device to: respond to an effect trigger operation for a target effect;

when filamentous object rendering occurs in an effect subject corresponding to the target effect, determine an effect guide map of the effect subject, wherein the effect guide map comprises a basic model of the effect subject and a key guide line representing a filamentous object;

performing rendering processing on the effect guide map to obtain and display a target effect picture of the target effect, wherein the target effect picture comprises the filamentous object formed after the key guide line is rendered

The computer program code for carrying out operations of the present disclosure may be written in one or more programming languages or combinations thereof. The programming languages include, but not limited to, object-oriented programming languages, such as Java, smalltalk, C++, and conventional procedural programming languages, such as the “C” language or similar programming languages. The program code may be executed entirely on the user's computer, executed partly on the user's computer, executed as a stand-alone software package, executed partly on the user's computer and partly on a remote computer, or executed entirely on the remote computer or a server. In the case of the remote computer, the remote computer may be connected to the user's computer through any type of network, including a local area network (LAN) or a wide area network (WAN), or it may be connected to an external computer (e.g., connected through the Internet using an Internet service provider).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The units described in connection with the embodiments disclosed herein may be implemented in a software manner. The names of the units do not constitute limitations of the units themselves in a certain case, for example, the first obtaining unit may also be referred to as “a unit for obtaining at least two internet protocol addresses”.

The functions described herein above may be performed, at least in part, by one or more hardware logic constituent elements. For example, without limitation, exemplary types of hardware logic constituent elements that may be used comprise: a Field Programmable Gate Array (FPGA), an Application Specific Integrated Circuits (ASIC), an Application Specific Standard Products (ASSP), a Systems On Chip (SOC), a Complex Programmable Logic Device (CPLD), and so on.

In the context of the present disclosure, the machine-readable medium may be a tangible medium that may contain or store a program for use by or for use in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combinations thereof. More specific examples of the machine-readable storage medium would comprise an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination thereof.

According to one or more embodiments of the present disclosure, Example 1 provides an effect processing method, comprising: responding to an effect trigger operation for a target effect;

when filamentous object rendering occurs in an effect subject corresponding to the target effect, determining an effect guide map of the effect subject, wherein the effect guide map comprises a basic model of the effect subject and a key guide line representing a filamentous object;

performing rendering processing on the effect guide map to obtain and display a target effect picture of the target effect, wherein the target effect picture comprises the filamentous object formed after the key guide line is rendered.

According to one or more embodiments of the present disclosure, Example 2 provides an effect processing method, comprising:
optionally, the step of, when filamentous object rendering occurs in an effect subject corresponding to the target effect, determining an effect guide map of the effect subject comprises:
determining an effect subject corresponding to the target effect;
if a presentation object of the effect subject includes a filamentous object, determining that filamentous object rendering occurs on the effect subject;
generating an effect guide map of the effect subject according to key guide line information and a basic model of the effect subject, the key guide line information comprising a position and/or a length of the key guide line.

According to one or more embodiments of the present disclosure, Example 3 provides an effect processing method, comprising:
optionally, the generating an effect guide map of the effect subject according to key guide line information and a basic model of the effect subject comprises:
obtaining a basic model of the effect subject for 3D modeling, and extracting key guide line information and rough rendering parameters preset with respect to the effect subject;
performing tile rendering for the basic model through the rough rendering parameters and key guide line information, to obtain the effect guide map of the effect subject.

According to one or more embodiments of the present disclosure, Example 4 provides an effect processing method, comprising:
optionally, the performing rendering processing on the effect guide map to obtain and display a target effect picture of the target effect comprises:
inputting the effect guide map into a pre-trained filamentous object rendering model, and outputting a target effect picture, the filamentous object rendering model being obtained by training through a predetermined guide map-rendering map sample image pair;
displaying the target effect picture of the target effect.

According to one or more embodiments of the present disclosure, Example 5 provides an effect processing method, comprising:
optionally, the step of training the filamentous object rendering model comprises:
building an initial conditional generative adversarial network model which comprises a generator and a multi-scale discriminator;
obtaining a training sample set comprising at one group of sample image pairs, each group of sample image pairs comprising a sample guide map and a sample rendering map;
training the generator and the multi-scale discriminator according to the sample image pairs to obtain the filamentous object rendering model.

According to one or more embodiments of the present disclosure, Example 6 provides an effect processing method, comprising:
optionally, the training the generator and the multi-scale discriminator according to the sample image pairs to obtain the filamentous object rendering model comprises:
taking the sample guide map in the sample image pair as input data of the generator;
constituting two sets of input data of the multi-scale discriminator based on an output result of the generator, and the sample guide map and sample rendering map in the sample image pair;
performing parameter adjustment for the generator and the multi-scale discriminator respectively according to an output result of the multi-scale discriminator with respect to the two set of input data, and in conjunction with a predetermined loss function;
after a training iteration completion condition is satisfied, taking the trained generator as the filamentous object rendering model.

According to one or more embodiments of the present disclosure, Example 7 provides an effect processing method, comprising:
optionally, the generator is represented with a given first network structure, and the multi-scale discriminator is represented with a given second network structure;
the loss function comprises: a generative adversarial loss function, a learning perceptual image patch similarity loss function and a random image patch loss function.

According to one or more embodiments of the present disclosure, Example 8 provides an effect processing method, comprising:
optionally, determining the sample guide map and sample rendering map in the sample image pair by rendering respectively through a predetermined rendering engine tool based on the same rendering parameters.

According to one or more embodiments of the present disclosure, Example 9 provides an effect processing method, comprising:
optionally, the step of determining the sample guide map and sample rendering map in the sample image pair comprises:
obtaining a sample subject including the filamentous object and sample rendering parameters, the sample rendering parameters comprising camera parameters, illumination parameters and physical simulation deformation parameters;
performing tile rendering for a sample modeling model of the sample subject through sample key guide line information of the sample subject in conjunction with the sample rendering parameters, to obtain the sample guide map of the sample subject;
performing offline rendering for the sample modeling model on a given offline rendering engine tool through the sample rendering parameters, to obtain the sample rendering map of the sample subject.

According to one or more embodiments of the present disclosure, Example 10 provides an effect processing method, comprising:
optionally, the filamentous object is hair.

According to one or more embodiments of the present disclosure, Example 11 provides an effect processing apparatus, comprising:
a responding module configured to respond to an effect trigger operation for a target effect;
a guide map determining module configured to, when filamentous object rendering occurs in an effect subject corresponding to the target effect, determine an effect guide map of the effect subject, the effect guide map comprising a basic model of the effect subject and a key guide line representing a filamentous object;
a processing and displaying module configured to perform rendering processing on the effect guide map to obtain and display a target effect picture of the target effect, wherein the target effect picture comprises the filamentous object formed after the key guide line is rendered.

The foregoing description is only illustrative of embodiments of the present disclosure and of the principles of the technology employed. It will be appreciated by those skilled in the art that the scope of the present disclosure is not limited to technical solutions formed by specific combinations of the above technical features, and meanwhile covers other technical solutions formed by any combinations of the above technical features or other equivalent features, for example, technical solutions formed by mutual replacement of the above features and technical features having similar functions disclosed in (not limited to) the present disclosure, without departing from the concept disclosed above.

In addition, while operations are depicted in a particular order, this should not be understood as requiring that such operations are performed in the particular order shown or in sequential order. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. An effect processing method, comprising:
responding to an effect trigger operation on a target effect;
in accordance with a determination that there is a filamentous object on an effect subject corresponding to the target effect to be rendered, determining an effect guide map of the effect subject, wherein the effect guide map comprises a basic model of the effect subject and a key guide line representing the filamentous object; and
performing rendering processing on the effect guide map to obtain and display a target effect picture of the target effect, wherein the target effect picture comprises the filamentous object formed after the key guide line being rendered.

2. The method of claim 1, wherein in accordance with a determination that there is a filamentous object on an effect subject corresponding to the target effect to be rendered, determining an effect guide map of the effect subject comprises:
determining the effect subject corresponding to the target effect;
in response to that a presentation object of the effect subject comprises the filamentous object, determining that there is the filamentous object on the effect subject to be rendered; and
generating the effect guide map of the effect subject based on key guide line information and the basic model of the effect subject, wherein the key guide line information comprises a position and/or a length of the key guide line.

3. The method of claim 2, wherein generating the effect guide map of the effect subject based on key guide line information and the basic model of the effect subject comprises:
obtaining the basic model of the effect subject for 3D modeling, and extracting the key guide line information and rough rendering parameters preset with respect to the effect subject; and
performing tile rendering on the basic model through the rough rendering parameters and the key guide line information, to obtain the effect guide map of the effect subject.

4. The method of claim 1, wherein performing rendering processing on the effect guide map to obtain and display a target effect picture of the target effect comprises:
inputting the effect guide map into a pre-trained filamentous object rendering model, and outputting the target effect picture, wherein the filamentous object rendering model is obtained by training based on a predetermined sample image pair of a guide map and a rendering map; and
displaying the target effect picture of the target effect.

5. The method of claim 4, wherein training the filamentous object rendering model comprises:
building an initial conditional generative adversarial network model comprising a generator and a multi-scale discriminator;
obtaining a training sample set comprising at least one group of sample image pairs, wherein each group of sample image pairs comprises a sample guide map and a sample rendering map; and
training the generator and the multi-scale discriminator based on the sample image pairs to obtain the filamentous object rendering model.

6. The method of claim 5, wherein training the generator and the multi-scale discriminator based on the sample image pairs to obtain the filamentous object rendering model comprises:
taking the sample guide map in the sample image pair as input data of the generator;
constituting two sets of input data of the multi-scale discriminator based on an output result of the generator and the sample guide map and sample rendering map in the sample image pair;
performing parameter adjustment for the generator and the multi-scale discriminator respectively based on output results of the multi-scale discriminator with respect to the two set of input data and in conjunction with a predetermined loss function; and
after a training iteration completion condition is satisfied, taking the trained generator as the filamentous object rendering model.

7. The method of claim 6, wherein the generator is represented by a given first network structure, and the multi-scale discriminator is represented by a given second network structure; and
the loss function comprises: a generative adversarial loss function, a learning perceptual image patch similarity loss function, and a random image patch loss function.

8. The method of claim 5, wherein the sample guide map and sample rendering map in the sample image pair are determined by rendering respectively through a predetermined rendering engine tool based on same rendering parameters.

9. The method of claim 1, wherein the filamentous object is hair.

10-12. (canceled)

13. An electronic device, comprising:
one or more processors;
a storage device for storing one or more programs, wherein,
the one or more programs, when executed by the one or more processors, cause the one or more processors to:
respond to an effect trigger operation on a target effect;
in accordance with a determination that there is a filamentous object on an effect subject corresponding to the target effect to be rendered, determine an effect guide map of the effect subject, wherein the effect guide map comprises a basic model of the effect subject and a key guide line representing the filamentous object; and
perform rendering processing on the effect guide map to obtain and display a target effect picture of the target effect, wherein the target effect picture comprises the filamentous object formed after the key guide line being rendered.

14. The device of claim 13, wherein the one or more programs causing the one or more processors to in accordance with a determination that there is a filamentous object on an effect subject corresponding to the target effect to be rendered, determining an effect guide map of the effect subject comprise instructions to:
determine the effect subject corresponding to the target effect;
in response to that a presentation object of the effect subject comprises the filamentous object, determine that there is the filamentous object on the effect subject to be rendered; and
generate the effect guide map of the effect subject based on key guide line information and the basic model of the effect subject, wherein the key guide line information comprises a position and/or a length of the key guide line.

15. The device of claim 14, wherein the one or more programs causing the one or more processors to generate the effect guide map of the effect subject based on key guide line information and the basic model of the effect subject comprise instructions to:
obtain the basic model of the effect subject for 3D modeling, and extracting the key guide line information and rough rendering parameters preset with respect to the effect subject; and
perform tile rendering on the basic model through the rough rendering parameters and the key guide line information, to obtain the effect guide map of the effect subject.

16. The device of claim 13, wherein the one or more programs causing the one or more processors to perform rendering processing on the effect guide map to obtain and display a target effect picture of the target effect comprise instructions to:
input the effect guide map into a pre-trained filamentous object rendering model, and outputting the target effect picture, wherein the filamentous object rendering model is obtained by training based on a predetermined sample image pair of a guide map and a rendering map; and
display the target effect picture of the target effect.

17. The device of claim 16, wherein the one or more programs causing the one or more processors to train the filamentous object rendering model comprise instructions to:
build an initial conditional generative adversarial network model comprising a generator and a multi-scale discriminator;
obtain a training sample set comprising at least one group of sample image pairs, wherein each group of sample image pairs comprises a sample guide map and a sample rendering map; and
train the generator and the multi-scale discriminator based on the sample image pairs to obtain the filamentous object rendering model.

18. The device of claim 17, wherein the one or more programs causing the one or more processors to train the generator and the multi-scale discriminator based on the sample image pairs to obtain the filamentous object rendering model comprise instructions to:
take the sample guide map in the sample image pair as input data of the generator;
constitute two sets of input data of the multi-scale discriminator based on an output result of the generator and the sample guide map and sample rendering map in the sample image pair;
perform parameter adjustment for the generator and the multi-scale discriminator respectively based on output results of the multi-scale discriminator with respect to the two set of input data and in conjunction with a predetermined loss function; and
after a training iteration completion condition is satisfied, take the trained generator as the filamentous object rendering model.

19. The device of claim 18, wherein the generator is represented by a given first network structure, and the multi-scale discriminator is represented by a given second network structure; and
the loss function comprises: a generative adversarial loss function, a learning perceptual image patch similarity loss function, and a random image patch loss function.

20. The device of claim 17, wherein the sample guide map and sample rendering map in the sample image pair are determined by rendering respectively through a predetermined rendering engine tool based on same rendering parameters.

21. The device of claim 13, wherein the filamentous object is hair.

22. A non-transitory storage medium containing computer-executable instructions, wherein the computer-executable instructions, when executed by one or more computer processors, are used to cause the one or more computer processors to:
respond to an effect trigger operation on a target effect;
in accordance with a determination that there is a filamentous object on an effect subject corresponding to the target effect to be rendered, determine an effect guide map of the effect subject, wherein the effect guide map comprises a basic model of the effect subject and a key guide line representing the filamentous object; and
perform rendering processing on the effect guide map to obtain and display a target effect picture of the target effect, wherein the target effect picture comprises the filamentous object formed after the key guide line being rendered.

23. A non-transitory storage medium of claim 22, wherein the computer-executable instructions causing the one or more processors to in accordance with a determination that there is a filamentous object on an effect subject corresponding to the target effect to be rendered, determine an effect guide map of the effect subject further cause the one or more processors to:
determine the effect subject corresponding to the target effect;
in response to that a presentation object of the effect subject comprises the filamentous object, determine that there is the filamentous object on the effect subject to be rendered; and
generate the effect guide map of the effect subject based on key guide line information and the basic model of the effect subject, wherein the key guide line information comprises a position and/or a length of the key guide line.
